(19) United States
(12) Patent Application Publication
(10) Pub. No.: US 2025/0184378 A1
(43) Pub. Date: Jun. 5, 2025

(54) METHOD AND DEVICE OF STREAM MERGING FOR SPEECH CO-HOSTING

(71) Applicant: Beijing Zitiao Network Technology Co., Ltd., Beijing (CN)

(72) Inventor: Peng LV, Beijing (CN)

(21) Appl. No.: 18/843,685

(22) PCT Filed: Mar. 2, 2023
(86) PCT No.: PCT/CN2023/079426

§ 371 Date: Sep. 3, 2024

(30) Foreign Application Priority Data
Mar. 3, 2022 (CN) 202210204767.0

(51) Int. Cl. H04L 65/1089; H04L 65/401

(52) U.S. Cl. CPC H04L 65/1089; H04L 65/4015

(57) ABSTRACT

The disclosure provides a method, device, electronic device, computer-readable medium, computer program product, and computer program for stream merging for speech co-hosting. In the method, a device of stream merging for speech co-hosting obtains a first speech stream comprising speech information of a co-hosting user corresponding to a co-hosting terminal; obtains a second speech stream and a first image, the second speech stream comprising speech information of a live streamer user corresponding to a live streamer terminal, the first image comprising image information of the live streamer user corresponding to the live streamer terminal; merges the first speech stream, the second speech stream, and the first image to obtain first merged streaming data; obtains a second image indicating image information of the co-hosting user; and encodes the second image and the first merged streaming data to obtain second merged streaming data.

### CROSS REFERENCE TO RELATED APPLICATIONS

This application claims priority to Chinese Patent Application No. 202210204767.0, filed with the Chinese Patent Office on Mar. 3, 2022, and entitled “METHOD AND DEVICE OF STREAM MERGING FOR SPEECH CO-HOSTING”, which is incorporated herein by reference in its entirety.

### FIELD

The present disclosure relates to the field of network technologies, and in particular, to a method, device, electronic device, computer-readable medium, computer program product, and computer program for stream merging for speech co-hosting.

### BACKGROUND

The live stream co-hosting scene refers to a scene in which the live streamer performs bidirectional audio and video interaction with the co-hosting guest. The audience can watch the audio and video interaction of the live streamer and the co-hosting guest. In a live stream co-hosting scene, a co-hosting guest may co-host with the live streamer through speech co-hosting.

In a scene in which a co-hosting guest co-hosts with a live streamer through speech co-hosting, not only can an audience terminal sense the existence of the co-hosting guest, but also the problems of high uplink bandwidth pressure of the co-hosting guest terminal and high consumption of central processing unit (CPU) resources and graphics processing unit (GPU) resources are reduced, which have become urgent technical problems to be solved.

### SUMMARY

A method, device, electronic device, computer-readable medium, computer program product, and computer program for stream merging for speech co-hosting are provided.

In a first aspect, an embodiment of the present disclosure provides a method of stream merging for speech co-hosting, which is implemented at a device of stream merging for speech co-hosting, comprising: obtaining a first speech stream comprising speech information of a co-hosting user corresponding to a co-hosting terminal; obtaining a second speech stream and a first image, the second speech stream comprising speech information of a live streamer user corresponding to a live streamer terminal, the first image comprising image information of the live streamer user corresponding to the live streamer terminal; merging the first speech stream, the second speech stream, and the first image to obtain first merged streaming data; obtaining a second image indicating image information of the co-hosting user; and encoding the second image and the first merged streaming data to obtain second merged streaming data.

In a second aspect, an embodiment of the present disclosure provides a device of stream merging for speech co-hosting, comprising: an obtaining module configured to obtain a first speech stream comprising speech information of a co-hosting user corresponding to a co-hosting terminal; the obtaining module further configured to obtain a second speech stream and a first image, the second speech stream comprising speech information of a live streamer user corresponding to a live streamer terminal, the first image comprising image information of the live streamer user corresponding to the live streamer terminal; a merging module configured to merge the first speech stream, the second speech stream, and the first image to obtain first merged streaming data; the obtaining module further configured to obtain a second image indicating image information of the co-hosting user; and an encoding module configured to encode the second image and the first merged streaming data to obtain second merged streaming data.

In a third aspect, an embodiment of the present disclosure provides an electronic device comprising a processor and a memory; the memory storing computer execution instructions; the processor executing the computer execution instructions stored in the memory to cause the processor to perform the method of stream merging for speech co-hosting according to the first aspect and various possible designs of the first aspect.

In a fourth aspect, an embodiment of the present disclosure provides a computer-readable medium storing program code for computer execution, the program code comprising instructions for performing the method of stream merging for speech co-hosting according to the first aspect and various possible designs of the first aspect.

In a fifth aspect, an embodiment of the present disclosure provides a computer program product comprising a computer program which, when executed by a processor, implements the method of stream merging for speech co-hosting according to the first aspect and the first aspect.

In a sixth aspect, an embodiment of the present disclosure provides a computer program for implementing the method of stream merging for speech co-hosting according to the first aspect and various possible designs of the first aspect.

### BRIEF DESCRIPTION OF THE DRAWINGS

To describe the technical solutions in the embodiments of the present disclosure or the related technologies more clearly, the following briefly introduces the accompanying drawings required for describing the embodiments or the related technologies. Apparently, the accompanying drawings in the following description show some embodiments of the present disclosure. Other drawings may also be obtained according to these drawings without creative efforts.

FIG. 1 is a schematic structural diagram of a speech co-hosting system in the related art.

FIG. 2 is a schematic flowchart of a method of stream merging for speech co-hosting according to an embodiment of the present disclosure.

FIG. 3 is a schematic structural diagram of a method of stream merging for speech co-hosting according to an embodiment of the present disclosure.

FIG. 4 is a schematic structural diagram of a method of stream merging for speech co-hosting according to an embodiment of the present disclosure.

FIG. 5 is a schematic structural diagram of a device of stream merging for speech co-hosting according to an embodiment of the present disclosure.

FIG. 6 is a structural schematic diagram of an electronic device according to an embodiment of the present disclosure.

### DETAILED DESCRIPTION

In order to make objects, technical solutions and advantages of the embodiments of the present disclosure more apparent, the technical solutions in the embodiments of the present disclosure will be described below in a clearly and fully understandable way in connection with the drawings related to the embodiments of the present disclosure. Obviously, the described embodiments are only a part but not all of the embodiments of the present disclosure. All other embodiments obtained by those of ordinary skill in the art without creative labor fall within the scope of protection of the present disclosure.

In recent years, live streaming from the initial form of one-way video display scene, i.e., the audience can only one-way watch the live streamer's video display, the development of today's live streaming multi-people co-hosting scene, i.e., a two-way audio-video interaction between the live streamer and co-hosting guests, the audience can watch an interaction process between the audio and video of the live streamer and co-hosting guests. In the scene of live streaming multi-people co-hosting, a co-hosting guest can be co-hosted with the live streamer through speech co-hosting.

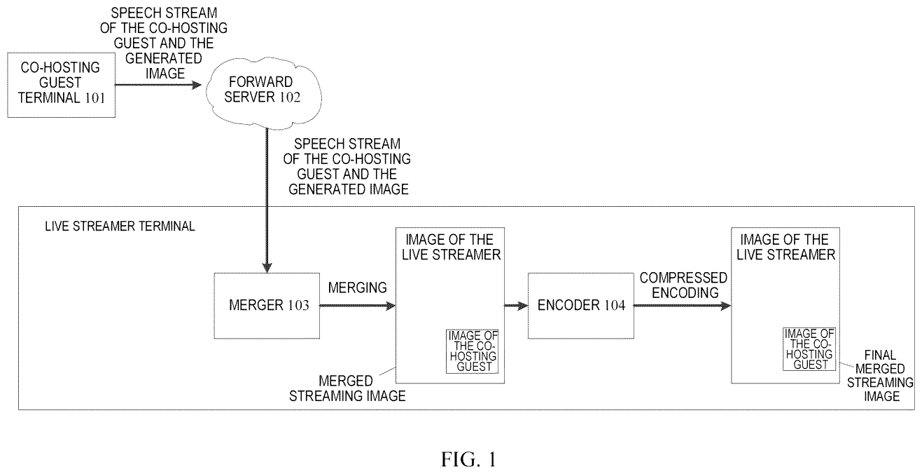

When the co-hosting guest is co-hosting with the live streamer using a method of speech co-hosting, in order to allow the audience terminal to perceive the presence of the co-hosting guest, as shown in FIG. 1, one way of implementation is as follows. The co-hosting guest terminal 101 first locally generates an image comprising an image of the user image and a sound wave effect, and then forwards the generated image and the speech of the co-hosting user to the live streamer terminal via the forward server 102. The live streamer terminal, via the merger 103 to merge the image, the speech of the co-hosting user, the image of the live streamer and the voice of the live streamer to obtain the merged streaming image and the stream merging voice. Further, after the live streamer terminal obtains the merged streaming image and the merged streaming voice, the encoder 104 is used to encode the merged streaming image and the merged streaming voice to obtain the final merged streaming image and the final merged streaming voice that can be uploaded to the streaming media server. In this way, the merged streaming image obtained by the audience terminal will comprise an image of the co-hosting guest, thereby enabling the audience to see the image of the co-hosting guest in the merged streaming image, i.e. enabling the audience terminal to perceive the presence of the co-hosting guest.

However, the above implementation method requires more uplink bandwidth resources, CPU resources or GPU resources of the co-hosting guest terminal. From another perspective, if any one of the uplink bandwidth resources, CPU resources, and GPU resources of the co-hosting guest terminal cannot be satisfied, the co-hosting guest terminal will not be able to co-host with the live streamer with high quality.

Therefore, in a scene where a co-hosting guest is co-hosting with the live streamer via speech co-hosting, it is a technical problem that needs to be urgently solved to allow the audience terminal to perceive the presence of the co-hosting guest, and at the same time reduce the problem of high uplink bandwidth pressure and high CPU and GPU consumption at the co-hosting guest terminal. Embodiments of the present disclosure provide a method of stream merging for speech co-hosting to solve the above problem.

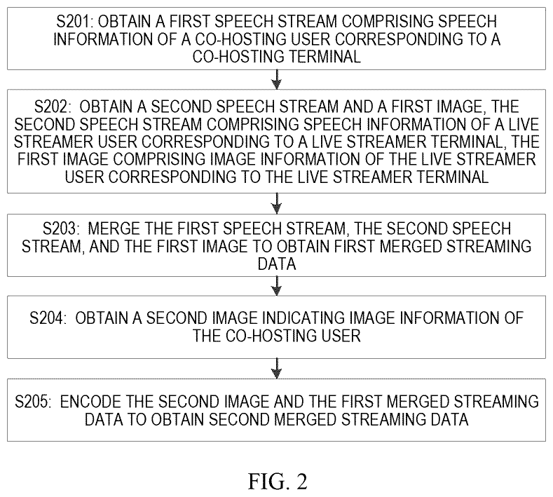

Referring to FIG. 2, FIG. 2 is a schematic flowchart of a method of stream merging for speech co-hosting according to an embodiment of the present disclosure. The method of the embodiments of the present disclosure can be applied to a device of stream merging for speech co-hosting. The method of stream merging for speech co-hosting comprises as follows.

At S201, a first speech stream comprising speech information of a co-hosting user corresponding to a co-hosting terminal is obtained.

In embodiments of the present disclosure, the co-hosting user refers to a user who is co-hosting with the live streamer by means of speech co-hosting, which may also be referred to as a co-hosting guest, for example. Herein, the co-hosting terminal refers to a terminal device used by the co-hosting user.

The first speech stream may be considered to be speech information of the co-hosting user when the co-hosting user is co-hosting with the live streamer through the method of speech co-hosting.

In a specific implementation, the device of stream merging for speech co-hosting may be included in the live streamer terminal or the merge server. Herein, the live streamer terminal is a terminal used for live streaming. In this case, one implementable way for the device of stream merging for speech co-hosting to obtain the first speech stream is that the device of stream merging for speech co-hosting obtains the first speech stream from a forward server, which is used to forward the speech information of the co-hosting user. It is to be understood that in the process of speech co-hosting, the co-hosting terminal usually sends the speech stream of the co-hosting user to the forward server first, and thus, in this implementable way, the device of stream merging for speech co-hosting may obtain the first speech stream directly from the forward server.

At S202, a second speech stream and a first image are obtained. The second speech stream comprises speech information of a live streamer user corresponding to a live streamer terminal, and the first image comprises image information of the live streamer user corresponding to the live streamer terminal.

Wherein the second speech stream can be considered to be speech information generated by the live streamer terminal and the co-hosting terminal when they are co-hosting by means of a manner of speech co-hosting. The first image is image information of the live streamer user.

In a specific implementation, the device of stream merging for speech co-hosting may be included in the live streamer terminal. In this case, the live streamer terminal may capture a first image corresponding to the live streamer user via a camera and capture a second speech streamer corresponding to the live streamer user via a microphone.

In specific embodiments, the device of stream merging for speech co-hosting may also be included in a merge server. In this case, an achievable way of obtaining a second speech stream and a first image by a device of stream merging for speech co-hosting is that the device of stream merging for speech co-hosting obtains a second speech stream and a first image from a forward server, which is also used to forward the image information and the speech information of the live streamer user. It is to be understood that in the process of speech co-hosting, the live streamer terminal usually sends the speech stream and the image information of the live streamer user to the forward server first, and thus, in this implementation, the merge server can obtain the second speech stream and the first image corresponding to the live streamer user directly from the forward server.

It is illustrated herein that the present disclosure embodiments do not limit the manner of obtaining the first image, the first speech stream, and the second speech stream. For example, the first image may be obtained first, and then the first speech stream and the second speech stream may be obtained, or the first image may be obtained at the same time as the first image, the first speech stream, and the second speech stream.

At S203, the first speech stream, the second speech stream, and the first image are merged to obtain first merged streaming data.

Regardless of whether the device of stream merging for speech co-hosting is a live streamer terminal or a merge server, usually, when the co-hosting user is co-hosting with the live streamer user by means of video co-hosting, after the device of stream merging for speech co-hosting receives the image and speech stream corresponding to the live streamer user as well as the image and speech stream corresponding to the co-hosting user, the device of stream merging for voice co-hosting merges the image of the live streamer user and the image of the co-hosting user, and finally pushes the mixed speech and the mixed image to the streaming media server.

However, when the co-hosting user is co-hosting with the live streamer user by means of speech co-hosting, since the co-hosting terminal usually does not capture the image of the co-hosting user, the corresponding image will not be generated. That is, in an embodiment of the present disclosure, during merging by the device of stream merging for speech co-hosting, the input information of the device of stream merging for speech co-hosting comprises: a first speech stream corresponding to the co-hosting user, a second speech stream corresponding to the live streamer user, and a first image corresponding to the live streamer user. And the image corresponding to the co-hosting user is not comprised.

In an embodiment of the present disclosure, the data obtained by the device of stream merging for speech co-hosting after performing merging processing of the first speech stream, the second speech stream, and the first image is referred to as the first merged streaming data. It is to be understood that the first merged streaming data may be divided into two parts, one part being the merged streaming speech data after the first speech stream and the second speech stream are mixed, and the other part being the image data comprising only the corresponding image of the live streamer user.

At S204, a second image indicating image information of the co-hosting user is obtained.

It is to be understood that since the input data of the device of stream merging for speech co-hosting comprises only a first speech stream, a second speech stream, and a first image when it performs the merging process, the information of the image of the co-hosting user is excluded from the merged first merged streaming data. This will result in the audience not being able to perceive the presence of the co-hosting user when using the audience terminal to watch the audio-video interaction process between the live streamer and the co-hosting user. Therefore, in order to solve the problem that the viewer terminal is unable to perceive the presence of the co-hosting user, the embodiments of the present disclosure, after obtaining the first merged streaming data, also obtain the image information (i.e., the second image) of the co-hosting user.

It is stated herein that the present disclosure embodiments do not limit the specific implementation of how the device of stream merging for speech co-hosting obtains the second image.

In one possible implementation, the device of stream merging for speech co-hosting may obtain speech stream information of the co-hosting user from the first merged streaming data, and then based on the speech stream information of the co-hosting user, separately determine an Internet Protocol (IP) address corresponding to the co-hosting terminal, and then go to a business server to obtain the user's image information of the user in the co-hosting terminal corresponding to the IP address.

In another possible implementation, the device of stream merging for speech co-hosting may obtain the speech streaming information of the co-hosting user from the first merged streaming data, and then automatically generate an image for the co-hosting user. It is to be understood that in such an implementation, when the co-hosting user comprises a plurality of users, the device of stream merging for speech co-hosting may generate a corresponding image for the plurality of co-hosting users separately.

As an example, the second image may comprise an image of the co-hosting user and a sound wave effect

At S205, the second image and the first merged streaming data are encoded to obtain second merged streaming data.

It is to be understood that, typically, when the device of stream merging for speech co-hosting obtains the first merged streaming data, it then encodes that first merged streaming data again to obtain the final merged streaming data. This final merged streaming data is then sent to the streaming media server. It is stated herein that the specific concepts of encoding and the detailed explanations can be referred to the descriptions in the related art and will not be repeated herein.

In an embodiment of the present disclosure, when the device of merging for speech co-hosting has obtained the first merged streaming data, the first merged streaming data is encoded with a piece of the second image corresponding to the co-hosting user. It is to be understood that since the first merged streaming data comprises the image information of the live streamer user, when the device of merging streaming for speech co-hosting encodes the first merged streaming data with the second image, the merged streaming data (i.e., the second merged streaming data) ultimately obtained comprises, in addition to the image of the live streamer user, the image of the co-hosting user, which enables the audience terminal to perceive the presence of the co-hosting user.

It is stated herein that the embodiments of the present disclosure do not limit the specific implementation of the device of merging streaming for speech co-hosting to encode the first merged streaming data with the second image corresponding to the co-hosting user piece by piece.

As an example, the merged streaming device for speech co-hosting may first encode the first merged streaming data (which also comprises encoding a first image in the first merged streaming data), and in an embodiment of the present disclosure, the first image corresponding to the first image after encoding is referred to as the encoded live streamer image; and then encode the second image, and in an embodiment of the present disclosure, the second image is further encoded, and in an embodiment of the present disclosure, the second image is referred to as the encoded image of co-hosting user; and finally the encoded image of co-hosting user is placed in an area in the encoded live streamer image.

As another example, the device of stream merging for speech co-hosting may simultaneously encode the first merged streaming data and the second image, and then place the encoded second image data in an area in the encoded first image.

It is to be understood that in the method of merging streams for speech-hosting provided in embodiments of the present disclosure, since it is a second image corresponding to the co-hosting user obtained by the device of merging streams for speech-hosting, as well as it is the second merged streaming data ultimately obtained by the device of merging streams for speech-hosting by encoding the first merged streaming data and the second image. As a result, it is no longer necessary for the co-hosting terminal to generate the image of the co-hosting user, and thus CPU or GPU consumption at the co-hosting terminal can be reduced, as well as upstream bandwidth resources at the co-hosting terminal for transmitting data can be reduced. In addition, since the image of the co-hosting user is encoded together with the first merged streaming data obtained by the merger at the encoding stage of the device of merging streaming for speech co-hosting, there is no need for the image of the co-hosting user to go through a communication process in which the co-hosting terminal sends the image of the co-hosting user to the forward server, and the forward server sends the image of the co-hosting user to the live streamer terminal. Therefore the clarity of the image of the co-hosting user in the eventually obtained second merged stream merging data is higher.

It can be seen from the above description that, in the embodiments of the present disclosure, a device of stream merging for speech co-hosting obtains a first speech stream comprising speech information of a co-hosting user corresponding to a co-hosting terminal; a device of stream merging for speech co-hosting obtains a second speech stream and a first image, the second speech stream comprising speech information of a live streamer user corresponding to a live streamer terminal, the first image comprising image information of the live streamer user corresponding to the live streamer terminal; a device of stream merging for speech co-hosting merges the first speech stream, the second speech stream, and the first image to obtain first merged streaming data; a device of stream merging for speech co-hosting obtains a second image indicating image information of the co-hosting user; a device of stream merging for speech co-hosting encodes the second image and the first merged streaming data to obtain second merged streaming data. Embodiments of the present disclosure are able to enable the audience terminal to perceive the presence of the co-hosting guest in a scene where the co-hosting user is co-hosting with the live streamer by means of speech co-hosting, and also reduce the problem of high upstream bandwidth pressure and CPU and GPU consumption at the co-hosting guest terminal.

In an embodiment of the present disclosure, on the basis of the embodiment in FIG. 2, after step S205, the method can further comprise: the device of stream merging for speech co-hosting sends the second merged streaming data to a streaming media server.

In embodiments of the present disclosure, when the device of stream merging for speech co-hosting obtains the second merged streaming data, it can then send that second merged streaming data to the streaming media server. Further, the streaming media server can then send the second merged streaming data to the audience terminal. It is to be understood that when the device of stream merging for speech-hosting obtains the second merged streaming data, the second merged streaming data comprises both the image information of the co-hosting user and the image information of the live streamer and comprises the speech information of the co-hosting user and the speech information of the live streamer. Therefore, when the streaming media server sends the second merged streaming data to the audience terminal, the audience terminal can see the image information of the co-hosting user as well as the image information of the live streamer, thereby enabling the audience terminal to perceive the presence of the co-hosting user.

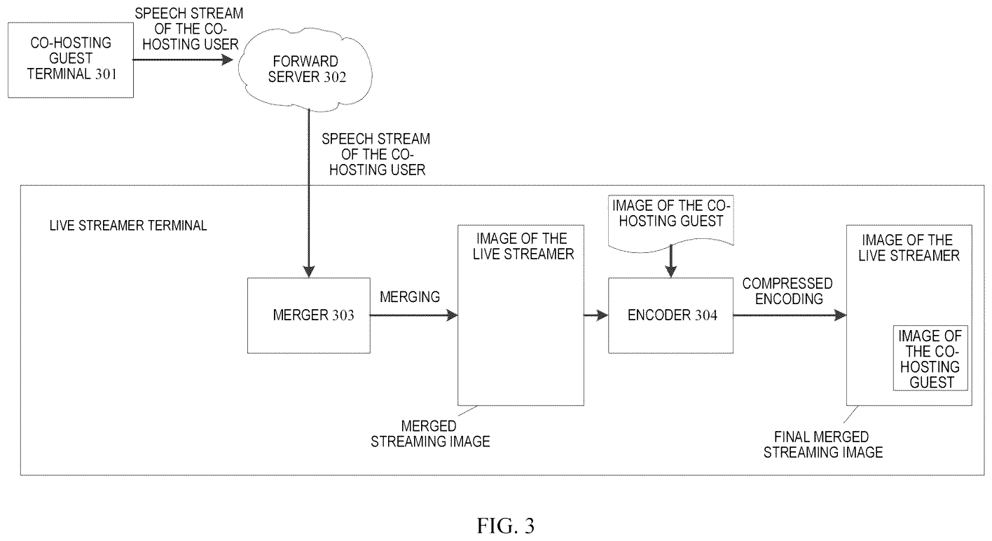

As an optional embodiment, the above-described device of stream merging for speech co-hosting is comprised in the live streamer terminal. As an example, FIG. 3 is a structural schematic diagram of a method of stream merging for speech-hosting when the device of stream merging for speech co-hosting provided by an embodiment of the present disclosure is contained in the live streamer terminal. As shown in FIG. 3, the live streamer terminal 301 pushes the speech stream of the co-hosting user to the forward server 302, and the live streamer terminal may pull the speech stream of the co-hosting user from the forward server 302, and then merge the speech stream of the live streamer user, the image of the live streamer user, and the speech stream of the co-hosting user via the merger 303 in the live streamer terminal to obtain the merged streaming data. Specifically, it is to be understood that the merged streaming data comprises merged streaming speech data (not shown in the figure) and merged streaming image data (i.e., the merged streaming image in the figure). After the stream merging is completed at the live streamer terminal, the encoding phase is entered. Specifically, an image of the co-hosting user is first obtained by the encoder 304, for example, the image comprises an image of the co-hosting user and a sound wave effect, and then the image of the co-hosting user is encoded together with the merged streaming data. It is to be understood that since the encoder encodes both the image of the live streamer and the merged streaming data. Thus, the final merged streaming data obtained will comprise both the image of live streamer and the image of co-hosting user (i.e., the final merged streaming image shown in the figure). At this point, the presence of the co-hosting guest is perceived at the audience terminal.

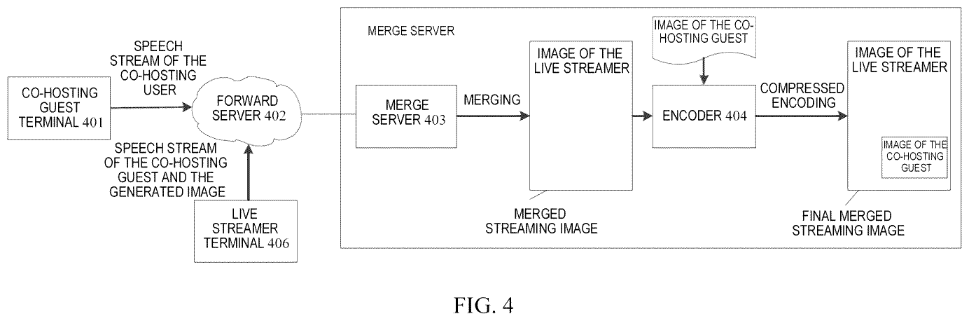

As an optional embodiment, the above-described device of stream merging for speech co-hosting is contained in a merge server. As an example, FIG. 4 shows a structural schematic diagram of a method of stream merging for speech-hosting when the device of stream merging for speech-hosting provided by an embodiment of the present disclosure is contained in a merge server. As shown in FIG. 4, the co-hosting terminal 401 pushes the speech stream of the co-hosting user to the forward server 402, and the live streamer terminal 406 also pushes the speech stream of the live streamer user and an image of the live streamer user to the forward server 402, and then the merger 403 in the merge server obtains the speech stream of the co-hosting user, the speech stream of the live streamer user, and the image of the live streamer user from the forward server 402 respectively and merges to obtain the merged streaming data. Specifically, it is to be understood that the merged streaming data comprises merged streaming speech data (not shown in the Figures) and merged streaming video data (i.e., the merged streaming image in the Figures). After the stream merging by the merge server is completed, the encoding phase is entered. Specifically, an image of the co-hosting user is first obtained by the encoder 404, e.g., the image comprises an image of the co-hosting user and an acoustic wave effect, and then the image of the co-hosting user is encoded together with the merged streaming data. It is to be understood that since the encoder encodes both the image of the live streamer and the merged streaming data, thus the final merged streaming data obtained will comprise both the image of the live streamer and the image of the co-hosting user (i.e., the final merged streaming image shown in the figure). At this point, the presence of the co-hosting guest is perceived at the audience terminal. The image of the co-hosting user may be an image uploaded and set by the user as the image to be presented during the co-hosting, or it may be a target image generated based on the user's predetermined original image and the user's predetermined image template as the image to be presented during the co-hosting, thereby enriching the image information at the co-hosting terminal and enhancing the user experience.

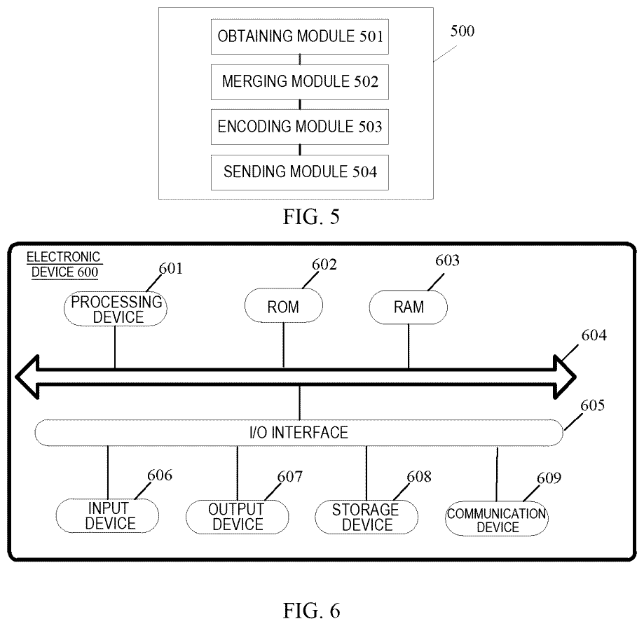

Corresponding to the method of stream merging for speech co-hosting of the embodiments above, FIG. 5 shows a structural block diagram of a device of stream merging for speech co-hosting 500 provided by embodiments of the present disclosure. For ease of illustration, only portions relevant to the embodiments of the present disclosure are shown.

Referring to FIG. 5, a device of stream merging for speech co-hosting 500 comprises: an obtaining module 501, a merging module 502, and an encoding module 503.

The obtaining module 501 configured to obtain a first speech stream comprising speech information of a co-hosting user corresponding to a co-hosting terminal; the obtaining module 501 is further configured to obtain a second speech stream and a first image, the second speech stream comprising speech information of a live streamer user corresponding to a live streamer terminal, the first image comprising image information of the live streamer user corresponding to the live streamer terminal; the merging module 502 is configured to merge the first speech stream, the second speech stream, and the first image to obtain first merged streaming data; the obtaining module 501 is further configured to obtain a second image indicating image information of the co-hosting user; and the encoding module 503 is configured to encode the second image and the first merged streaming data to obtain second merged streaming data.

In an embodiment of the present disclosure, the obtaining module 501 is specifically configured to obtain the first speech stream from a forward server, the forward server configured to forward speech information of the co-hosting user.

In one embodiment of the present disclosure, the device of stream merging for speech co-hosting 500 is comprised in the live streamer terminal.

In one embodiment of the present disclosure, the device of stream merging for speech co-hosting 500 is comprised in a merge server.

In an embodiment of the present disclosure, the obtaining module 501 is specifically configured to obtain the second speech stream and the first image from the forward server, the forward server further configured to forward image information and speech information of the live streamer user.

In an embodiment of the present disclosure, the second image comprises an image and an acoustic wave effect of the co-hosting user.

In an embodiment of the present disclosure, the device of stream merging for speech co-hosting 500 further includes a sending module 504, configured to send the second merged streaming data to a streaming media server.

The device provided by the embodiment of the present disclosure can be used to execute the technical solution of the above method embodiment, and the implementation principle and technical effect thereof are similar, and the embodiment of the present disclosure will not be repeated herein.

In order to implement the described embodiments, the embodiments of the present disclosure further provide an electronic device.

Referring to FIG. 6, it shows a structural schematic diagram of an electronic device 600 suitable for use in implementing an embodiment of the present disclosure, which may be a terminal device or a server. Among other things, the terminal device may include, but is not limited to, a device such as a mobile phone, a laptop computer, a digital broadcast receiver, a Personal Digital Assistant (PDA), a Tablet PC (Portable Android Device (PAD)), a Portable Media Player (PMP), an in-vehicle terminal (e.g., an in-vehicle navigation terminal), and the like, and a fixed terminal such as a Digital Television (DTV), a desktop computer, and the like. The electronic device 600 illustrated in FIG. 6 is merely an example and should not impose any limitation on the functions and scope of use of the embodiments of the present disclosure.

As shown in FIG. 6, the electronic device 600 may include a processing device 601 (e.g., a CPU, a GPU, etc.) that may perform various appropriate actions and perform various functions based on a program stored in a read-only memory (Read Only Memory, or ROM) 602, or a program loaded from a storage device 608 into a random access memory (RAM) 603. In the RAM 603, various programs and data necessary for the operation of the electronic device 600 are also stored. The processing device 601, the ROM 602, and the RAM 603 are connected to each other via the bus 604. An input/output (Input/Output, or I/O) interface 605 is also connected to the bus 604.

Typically, the following devices may be connected to the I/O interface 605: an input device 606 including, for example, a touch screen, a touch pad, a keyboard, a mouse, a camera, a microphone, an accelerometer, a gyroscope, and the like; an output device 607 including, for example, a liquid crystal display (Liquid Crystal Display (LCD)), a speaker, a vibrator, and the like; a storage device 608 including, for example, a tape, a hard drive, and the like; and a communication device 608. The communication device 609 may allow the electronic device 600 to communicate wirelessly or wiredly with other devices to exchange data. While FIG. 6 illustrates electronic device 600 with various devices, it should be understood that it is not required to implement or have all of the illustrated devices. More or fewer devices or equipment may alternatively be implemented or possessed.

In particular, according to embodiments of the present disclosure, the process described above with reference to the flowchart may be implemented as a computer software program. For example, embodiments of the present disclosure include a computer program product comprising a computer program carried on a computer readable medium, the computer program comprising program code for performing the method shown in the flowchart. In such embodiments, the computer program may be downloaded and installed from a network via a communication device 609, or from a storage device 608, or from a ROM 602. In the event that the computer program is executed by the processing device 601, the above-described functions defined in the method of the presently disclosed embodiment are performed.

It is noted that the computer-readable medium described above in the embodiments of the present disclosure may be a computer-readable signal medium or a computer-readable storage medium or any combination of the above. The computer-readable storage medium may, for example, be—but is not limited to—a system, device, or appliance of electricity, magnetism, light, electromagnetism, infrared, or semiconductors, or any combination of the above. More specific examples of computer-readable storage media may include but are not limited to: an electrical connection with one or more wires, a portable computer disk, a hard drive, RAM, ROM, Erasable Programmable Read Only Memory (EPROM) or flash memory, optical fiber, portable compact disk read-only memory (Compact Disk Read-Only Memory, or CDROM), optical storage device, magnetic storage device, or any suitable combination of the foregoing. In embodiments of the present disclosure, a computer-readable storage medium may be any tangible medium containing or storing a program that may be used by or in combination with an instruction execution system, apparatus, or device. And in embodiments of the present disclosure, a computer-readable signaling medium may comprise a data signal propagated in baseband or as part of a carrier carrying computer-readable program code. Such propagated data signals may take a variety of forms, including, but not limited to, electromagnetic signals, optical signals, or any suitable combination of the foregoing. The computer-readable signaling medium may also be any computer-readable medium other than a computer-readable storage medium that sends, propagates or transmits a program for use by, or in conjunction with, an instruction-executing system, apparatus or device. The program code contained on the computer-readable medium may be transmitted using any suitable medium, including, but not limited to: wire, fiber optic cable, Radio Frequency (RF), etc., or any suitable combination of the foregoing.

The computer-readable medium may be contained in the electronic device; or it may be present separately and not assembled into the electronic device.

The above-described computer-readable medium carries one or more programs that, when the above-described one or more programs are executed by the electronic device, cause the electronic device to perform the methods shown in the above-described embodiments.

Computer program code for performing the operations of the present disclosure may be written in one or more programming languages or combinations thereof, including object-oriented programming languages-such as Java, Smalltalk, C++—and conventional procedural programming languages—such as the “C” language or similar programming languages. The program code may be executed entirely on the user's computer, partially on the user's computer, as a stand-alone software package, partially on the user's computer and partially on a remote computer, or entirely on a remote computer or server. In the case involving a remote computer, the remote computer may be connected to the user computer via any kind of network-including a local area network (LAN) or a wide area network (WAN)—or, alternatively, may be connected to an external computer (e.g., using an Internet service provider to connect via the Internet).

The architecture, functionality, and operation of the possible implementations of the product. In this regard, each box in the flowchart or block diagram may represent a module, program segment, or portion of code that contains one or more executable instructions for implementing a specified logical function. It should also be noted that in some implementations as replacements, the functions indicated in the boxes may also occur in a different order than that indicated in the accompanying drawings. For example, two consecutively represented boxes can actually be executed substantially in parallel, and they can sometimes be executed in reverse order, depending on the function involved. It is also noted that each of the boxes in the block diagram and/or flowchart, and combinations of the boxes in the block diagram and/or flowchart, may be implemented with a dedicated hardware-based system that performs the specified function or operation, or may be implemented with a combination of dedicated hardware and computer instructions.

The units described as being involved in embodiments of the present disclosure may be implemented by way of software or may be implemented by way of hardware. Wherein the name of the unit does not in some cases constitute a limitation of the unit itself, for example, the first obtaining unit may also be described as “a unit for obtaining at least two Internet Protocol addresses”.

The functions described above herein may be performed, at least in part, by one or more hardware logic components. For example, without limitation, example types of hardware logic components that may be used include: Field Programmable Gate Arrays (FPGAs), Application Specific Integrated Circuits (ASICs), Application Specific Standard Parts (ASSPs), Systems on Chip (SOCs), Complex Programmable Logic Device (CPLD), and so on.

In the context of the present disclosure, a machine-readable medium may be a tangible medium that may contain or store a program for use by or in conjunction with an instruction execution system, device, or equipment. The machine-readable medium may be a machine-readable signal medium or a machine-readable storage medium. The machine-readable medium may include, but is not limited to, an electronic, magnetic, optical, electromagnetic, infrared, or semiconductor system, device, or equipment, or any suitable combination of the foregoing. More specific examples of machine-readable storage media would include electrical connections based on one or more wires, portable computer discs, hard drives, RAM, ROM, EPROM or flash memory, optical fibers, CD-ROMs, optical storage devices, magnetic storage devices, or any suitable combination of the foregoing.

In a first aspect, according to one or more embodiments of the present disclosure, a method of stream merging for speech co-hosting is provided, comprising:
obtaining a first speech stream comprising speech information of a co-hosting user corresponding to a co-hosting terminal;
obtaining a second speech stream and a first image, the second speech stream comprising speech information of a live streamer user corresponding to a live streamer terminal, the first image comprising image information of the live streamer user corresponding to the live streamer terminal;
merging the first speech stream, the second speech stream, and the first image to obtain first merged streaming data;
obtaining a second image indicating image information of the co-hosting user; and
encoding the second image and the first merged streaming data to obtain second merged streaming data.

According to one or more embodiments of the present disclosure, the obtaining a first speech stream comprises:
obtaining the first speech stream from a forward server, the forward server configured to forward speech information of the co-hosting user.

According to one or more embodiments of the present disclosure, the device of stream merging for speech co-hosting is comprised in the live streamer terminal.

According to one or more embodiments of the present disclosure, the device of stream merging for speech co-hosting is comprised in a merge server.

According to one or more embodiments of the present disclosure, obtaining a second speech stream and a first image comprises:
obtaining the second speech stream and the first image from the forward server, the forward server further configured to forward image information and speech information of the live streamer user.

According to one or more embodiments of the present disclosure, the second image comprises a target image and an acoustic wave effect, the target image configured to indicate the co-hosting user.

According to one or more embodiments of the present disclosure, after obtaining the second merged streaming data, the method further comprises:
sending the second merged streaming data to a streaming media server.

In a second aspect, in one or more embodiments of the present disclosure, a device of stream merging for speech co-hosting is provided, comprising:
an obtaining module configured to obtain a first speech stream comprising speech information of a co-hosting user corresponding to a co-hosting terminal;
the obtaining module further configured to obtain a second speech stream and a first image, the second speech stream comprising speech information of a live streamer user corresponding to a live streamer terminal, the first image comprising image information of the live streamer user corresponding to the live streamer terminal;
a merging module configured to merge the first speech stream, the second speech stream, and the first image to obtain first merged streaming data;
the obtaining module further configured to obtain a second image indicating image information of the co-hosting user; and
an encoding module configured to encode the second image and the first merged streaming data to obtain second merged streaming data.

According to one or more embodiments of the present disclosure, the obtaining module is specifically configured to:
obtain the first speech stream from a forward server, the forward server configured to forward speech information of the co-hosting user.

According to one or more embodiments of the present disclosure, the device of stream merging for speech co-hosting is comprised in the live streamer terminal.

According to one or more embodiments of the present disclosure, the device of stream merging for speech co-hosting is comprised in a merge server.

According to one or more embodiments of the present disclosure, the obtaining module is specifically configured to:
obtain the second speech stream and the first image from the forward server, the forward server further configured to forward image information and speech information of the live streamer user.

According to one or more embodiments of the present disclosure, the second image comprises a target image and an acoustic wave effect, the target image configured to indicate the co-hosting user.

According to one or more embodiments of the present disclosure, the device of stream merging for speech co-hosting further comprises:
a sending module configured to send the second merged streaming data to a streaming media server after obtaining the second merged streaming data.

In a third aspect, according to one or more embodiments of the present disclosure, an electronic device is provided, comprising: at least one processor and a memory;
the memory storing computer execution instructions;
the at least one processor executing the computer execution instructions stored in the memory to cause the at least one processor to perform the method of stream merging for speech co-hosting according to the first aspect and various possible designs of the first aspect.

In a fourth aspect, according to one or more embodiments of the present disclosure, a computer readable medium is provided, storing computer instructions, the processor executing the computer execution instructions to implement the method of stream merging for speech co-hosting according to the first aspect above and in various possible designs of the first aspect.

In a fifth aspect, according to one or more embodiments of the present disclosure, a computer program product is provided, comprising a computer program which, when executed by a processor, implements the method of stream merging for speech co-hosting according to the first aspect above and in various possible designs of the first aspect.

In a sixth aspect, according to one or more embodiments of the present disclosure, a computer program is provided, for implementing the method of stream merging for speech co-hosting according to the first aspect above and in various possible designs of the first aspect.

Embodiments of the present disclosure provide a method, a device, electronic device, computer-readable medium, computer program product, and computer program for stream merging for speech co-hosting. In the method, a device of stream merging for speech co-hosting obtains a first speech stream comprising speech information of a co-hosting user corresponding to a co-hosting terminal; a device of stream merging for speech co-hosting obtains a second speech stream and a first image, the second speech stream comprising speech information of a live streamer user corresponding to a live streamer terminal, the first image comprising image information of the live streamer user corresponding to the live streamer terminal; merges the first speech stream, the second speech stream, and the first image to obtain first merged streaming data; obtains a second image indicating image information of the co-hosting user; and encodes the second image and the first merged streaming data to obtain second merged streaming data. Since in the method of merging streams for speech co-hosting provided in embodiments of the present disclosure, it is a second image corresponding to the co-hosting user that is obtained by the device of stream merging for speech co-hosting, as well as it is the second merged streaming data that is ultimately obtained by the device of stream merging for speech co-hosting by encoding the first merged streaming data and the second image. Therefore, it is no longer necessary for the co-hosting terminal to generate the second image of the co-hosting user, so as to satisfy the situation that the audience terminal is able to perceive the presence of the co-hosting user, and thereby also reduce the problem of a high upstream bandwidth pressure and a high consumption of CPU and GPU at the co-hosting terminal.

The above description is only a preferred embodiment of the present disclosure and an illustration of the technical principles applied. It should be understood by those skilled in the art that the scope of the disclosure involved in the present disclosure is not limited to technical solutions formed by a particular combination of the above technical features, but also covers other technical solutions formed by any combination of the above technical features or their equivalent features without departing from the above disclosed concept. For example, a technical solution formed by interchanging the above-mentioned features with technical features having similar functions disclosed in the present disclosure (but not limited to).

Furthermore, although the operations are depicted using a particular order, this should not be construed as requiring that the operations be performed in the particular order shown or in a sequential order. Multi-tasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or method logic actions, it should be understood that the subject matter defined in the appended claims is not necessarily limited to the particular features or actions described above. Rather, the particular features and actions described above are merely exemplary forms of implementing the claims.

1. A method of stream merging, comprising:
obtaining a first speech stream comprising speech information of a first user associated with a live streaming interaction event;
obtaining a second speech stream and a first image, the second speech stream comprising speech information of a second user associated with the live streaming interaction event c, the first image comprising image information of the second user;
merging the first speech stream, the second speech stream, and the first image to obtain first merged streaming data;
obtaining a second image indicating image information of the first user; and
encoding the second image and the first merged streaming data to obtain second merged streaming data.

2. The method of claim 1, wherein the obtaining a first speech stream comprises:
obtaining the first speech stream from a forward server, the forward server configured to forward speech information of the first user.

3. The method of claim 1, wherein a device for stream merging is comprised in a live streamer terminal.

4. The method of claim 1, wherein the device for stream merging is comprised in a merge server.

5. The method of claim 4, wherein obtaining a second speech stream and a first image comprises:
obtaining the second speech stream and the first image from the forward server, the forward server further configured to forward image information and speech information of the second user.

6. The method of claim 1, wherein the second image comprises a target image and visual effect associated with the first speech stream, the target image configured to indicate the first user.

7. The method of claim 1, wherein after obtaining the second merged streaming data, the method further comprises:
sending the second merged streaming data to a streaming media server.

8. (canceled)

9. An electronic device comprising a processor and a memory;
the memory storing computer execution instructions;
the processor executing the computer execution instructions stored in the memory to cause the processor to perform the acts comprising:
obtaining a first speech stream comprising speech information of a first user associated with a live streaming interaction event;
obtaining a second speech stream and a first image, the second speech stream comprising speech information of a second user associated with the live streaming interaction event, the first image comprising image information of the second user;
merging the first speech stream, the second speech stream, and the first image to obtain first merged streaming data;
obtaining a second image indicating image information of the first user; and
encoding the second image and the first merged streaming data to obtain second merged streaming data.

10. A non-transitory computer-readable storage medium storing program code for computer execution, the program code comprising instructions for performing the acts comprising:
obtaining a first speech stream comprising speech information of a first user associated with a live streaming interaction event;
obtaining a second speech stream and a first image, the second speech stream comprising speech information of a second user associated with the live streaming interaction event, the first image comprising image information of the second user;
merging the first speech stream, the second speech stream, and the first image to obtain first merged streaming data;
Preliminary Amendment: First Action Not Yet Received
obtaining a second image indicating image information of the first user; and
encoding the second image and the first merged streaming data to obtain second merged streaming data.

11. (canceled)

12. (canceled)

13. The method of claim 1, wherein:
both the first user and the second user are live streamer users; or
the first user is an audience user and the second user is a live streamer user.

14. The electronic device of claim 9, wherein:
both the first user and the second user are live streamer users; or
the first user is an audience user and the second user is a live streamer user.

15. The electronic device of claim 9, wherein the obtaining a first speech stream comprises:
obtaining the first speech stream from a forward server, the forward server configured to forward speech information of the first user.

16. The electronic device of claim 9, wherein a device for stream merging is comprised in a live streamer terminal.

17. The electronic device of claim 9, wherein the device for stream merging is comprised in a merge server.

18. The electronic device of claim 17, wherein obtaining a second speech stream and a first image comprises:
obtaining the second speech stream and the first image from the forward server, the forward server further configured to forward image information and speech information of the second user.

19. The electronic device of claim 9, wherein the second image comprises a target image and a visual effect associated with the first speech stream, the target image configured to indicate the first user.

20. The electronic device of claim 9, wherein after obtaining the second merged streaming data, the method further comprises:
sending the second merged streaming data to a streaming media server.

21. The non-transitory computer-readable storage medium of claim 10, wherein:
both the first user and the second user are live streamer users; or
the first user is an audience user and the second user is a live streamer user.

22. The non-transitory computer-readable storage medium of claim 10, wherein the obtaining a first speech stream comprises:
obtaining the first speech stream from a forward server, the forward server configured to forward speech information of the first user.

23. The non-transitory computer-readable storage medium of claim 10, wherein a device for stream merging is comprised in a live streamer terminal.
